(19) United States
(12) Patent Application Publication
(10) Pub. No.: US 2009/0256861 A1
(43) Pub. Date: Oct. 15, 2009

(54) Device and Method for Managing the Orientation of Information Being Displayed on the Screen of a Device

(75) Inventors: Heiko K. Sacher, Menlo Park, CA (US); Andrew K. Wells, Grayslake, IL (US); Mark J. Young, San Francisco, CA (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., Libertyville, IL (US)

(21) Appl. No.: 12/343,141

(22) Filed: Dec. 23, 2008

Related U.S. Application Data
(60) Provisional application No. 61/018,100, filed on Dec. 31, 2007.

(51) Int. Cl. G09G 5/32; G09G 5/00

(52) U.S. Cl. 345/650; 345/184

(57) ABSTRACT

A hand-held device and method for managing the orientation of information being displayed on the screen of a hand-held device is provided for devices having a two part slidable housing including a first housing and a second housing where the two housings are adapted to slide separately in multiple directions relative to one another along a corresponding path substantially parallel to a front facing of the device between an opened position and a closed position. The method takes into account a detected use mode, such as whether the device is engaged in a voice call communication, and a detected device configuration to determine the orientation of the information to be displayed on the device screen. When the first housing is slid relative to the second housing between a closed position and an opened position in a first direction, the information is displayed having a portrait orientation. The information is displayed having a landscape orientation, when the first housing is slid relative to the second housing between a closed position and an opened position in a second direction. When the hand-held device is in a voice call and the first housing is slid relative to the second housing between an opened position and a closed position, the information is displayed having a portrait orientation. When the hand-held device is not in a voice call and the first housing is slid relative to the second housing between an opened position and a closed position, the orientation of the information being displayed is not changed.

### FIELD OF THE INVENTION

The present invention relates generally to a device and a method for managing the conveyance of information on a display screen of a device, and more particularly, to the management of the orientation of the information being displayed for use with several different device configurations and device functions.

### BACKGROUND OF THE INVENTION

Devices are increasingly incorporating multiple types of functionality, where some functions may have a preference for operating the device in one orientation, while a different function may have a preference for an alternative orientation. Similarly, the hardware may be physically reconfigured to support alternative use cases and corresponding functions. For example, while cellular radio telephones traditionally supported wireless wide area voice communications, at least some segments of the user base additionally make extensive use of text messaging and/or data communications.

While using voice communications an abbreviated keypad including a bell numberic keypad is often preferred, for example, for purposes of entering a telephone number to be dialed, or to input selections from a menu system. Alternatively, while text messaging a full qwerty style keypad may be more desirable. A preferred shape of the device can similarly be linked to the type of function that is currently being used. For example when engaging in a voice communication, a relatively narrow elongated device which can be held by the hand of the user up against the side of the face, and which extends between the user's ear and the user's mouth is preferred. Alternatively, while in text mode a width which allows both hands to grip alternative sides of the phone is desirable.

In order to support different functionality and use cases, a device that can be reconfigured in multiple ways to support the different use cases can be beneficial. One particular form factor for hand held devices includes devices that have a two part housing, where one of the two parts of the housing slides relative to the other one of the two parts of the housing, where each generally slides along respective ones of substantially parallel paths, which are also generally parallel to the front facing of the device.

In at least some devices, the two parts of the housing may be capable of sliding in multiple directions from a closed position to one of multiple opened position, in which opening in one direction extends the overall length of the device, and in which opening in another direction extends the overall width of the device. In some instances, opening the device will expose a keypad for use by the user in interacting with the device. For example, opening the device in the direction that extends the overall length of the device may expose to the user a bell numeric keypad, and opening the device in the direction that extends the overall width of the device may expose to the user a qwerty keypad.

Along with changing the orientation of the device, if the device has a display it may be desirable to similarly change the orientation of the information being presented on the display. Historically, some devices have attempted to manage the orientation of the information being presented on the display screen through the use of tilt sensor and accelerometers, or manage the orientation of the information being presented on the display through the use of orientation switching paradigms that match the textual presentation orientation on the display to each specific hardware configuration. However some hardware configurations may be usable in multiple orientations, which may not be definitively readily detectable using various sensors. Furthermore, some of these solutions limit the user's ability to switch the hardware configuration independent of the orientation of the information being conveyed on the display, and vice versa, which in turn can result in unintended orientation switches that disrupt the user's work flow, as well as disrupt switching between task flow.

Consequently, the present inventors have recognized that it would be beneficial if the device provided display orientation switching taking into account a context dependent combination of hardware triggered and user controlled input.

### SUMMARY OF THE INVENTION

The present invention provides a method for managing the orientation of information being displayed on the screen of a hand-held device having a two part slidable housing including a first housing and a second housing where the two housings are adapted to slide separately in multiple directions relative to one another along a corresponding path substantially parallel to a front facing of the device between an opened position and a closed position. The method includes displaying information on the screen in one of a landscape orientation or a portrait orientation. The first housing of the hand-held device is then slid relative to the second housing of the hand-held device from a closed position, where the first housing and the second housing substantially overlap, to an opened position where at least a portion of the first housing or a portion of the second housing move from an overlapping position to a non-overlapping position, relative to the other one of the first housing and the second housing. The information is displayed on the screen in a portrait orientation, if the first housing slides relative to the second housing in a first direction, and the information is displayed on the screen in a landscape orientation, if the first housing slides relative to the second housing in a second direction, which is substantially perpendicular to the first direction. The first housing of the hand-held device is then slid relative to the second housing of the hand-held device from an opened position to a closed position without changing the orientation of the information being displayed on the screen.

In at least one embodiment, the hand-held device is a radiotelephone adapted for supporting a voice call communication connection, where when the hand-held device is not in a voice call communication connection, sliding the first housing of the hand-held device relative to the second housing of the hand-held device from an opened position to a closed position does not change the orientation of the information being displayed on the screen. When the hand-held device is in a voice call communication connection, and the first housing of the hand-held device is slid relative to the second housing of the hand-held device from an opened position to a closed position, the orientation of the information being displayed on the screen is presented in a portrait orientation.

In at least a further embodiment, the method further includes providing a user actuatable switch for toggling the orientation of the information being displayed on the screen between a landscape orientation and a portrait orientation, when the first housing of the hand-held device is in a closed position relative to the second housing of the hand-held device. The method further includes detecting the actuation of the user actuatable switch, and if the user actuatable switch is detected as having been actuated, then switching the orientation of the information being displayed on the screen between a landscape orientation and a portrait orientation.

The present invention further provides a hand-held device having a two part slidable housing. The hand-held device includes a first housing including a display, and a second housing including a keypad, where the first housing and the second housing are adapted to slide separately in multiple directions relative to one another along a corresponding path substantially parallel to a front facing of the device between an opened position and a closed position. The hand-held device further includes a display controller, which is adapted for displaying information on the screen in one of a landscape orientation or a portrait orientation, where if the first housing is slid relative to the second housing from a closed position to an opened position in a first direction the information will be displayed on the screen in a portrait orientation, and if the first housing slides relative to the second housing from a closed position to an opened position in a second direction, which is substantially perpendicular to the first direction, the information will be displayed on the screen in a landscape orientation. The display controller is further adapted to maintain the orientation of the information being displayed on the screen, if the first housing of the hand-held device is slid relative to the second housing of the hand-held device from an opened position to a closed position.

These and other features, and advantages of this invention are evident from the following description of one or more preferred embodiments of this invention, with reference to the accompanying drawings.

### BRIEF DESCRIPTION OF THE DRAWINGS

FIG. 1 is an exemplary hand-held device having a two part housing, which each move relative to one another along at least a first set of substantially parallel paths;

FIG. 2 is an exemplary hand-held device having a two part housing, which each move relative to one another along a second set of substantially parallel paths in addition to the first set of substantially parallel paths, illustrated in FIG. 1;

FIGS. 3A and 3B are plan views of an exemplary hand-held device in respective closed portrait and closed landscape positions;

FIGS. 4A and 4B are plan views of an exemplary hand-held device in respective opened portrait and opened landscape positions;

FIG. 5 is a block diagram of a hand-held device for managing the conveyance of information on a device display, in accordance with at least one embodiment of the present invention;

FIG. 6 is a flow diagram of a method for managing the conveyance of information on a device display, in accordance with at least one embodiment of the present invention;

FIG. 7 is a more detailed flow diagram of a method for managing the conveyance of information on a device display, in accordance with at least one aspect of the present invention, when the device is not in a voice call mode; and

FIG. 8 is a more detailed flow diagram of a method for managing the conveyance of information on a device display, in accordance with at least one aspect of the present invention, when the device is in a voice call mode.

### DETAILED DESCRIPTION OF THE PREFERRED EMBODIMENT(S)

While the present invention is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated.

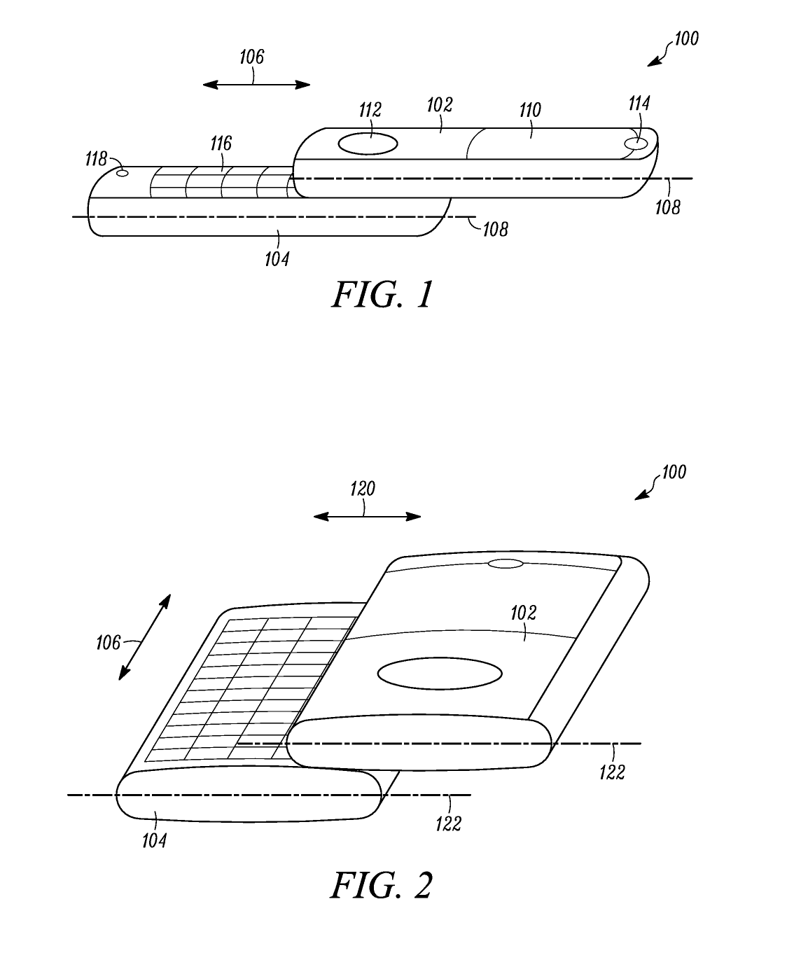

FIG. 1 illustrates an exemplary hand-held device 100, such as a wireless communication device, having a two part housing including an upper housing 102 or slider portion, and a lower housing 104 or base portion, which each move in a first direction 106 relative to one another between an opened position and a closed position along at least a first set of substantially parallel paths 108, where the two part housing corresponds to a slider configuration. In the illustrated example, the upper housing 102 includes a display area or screen 110, a user input area 112 and one or more speaker ports 114. The user input area can include one or more user actuatable elements including a navigational input section for example allowing for the four-way movement of a cursor on the display (i.e. up, down, left and right), and a selection input section for example allowing for the selection of highlighted display elements. In some instances the selection input section can be incorporated as elements or icons on a touch sensitive display, while in other instances the selection input section can be incorporated as a button having a mechanical actuator. In the same or other instances, at least portions of the navigational input section may overlap portions of the selection input section.

The lower housing 104 includes a further user input section in the form of a keypad 116, which can be selectively exposed to a user depending upon the position of the first housing relative to the second housing, as well as a microphone 118. In some instances, at least one of the upper housing 102 and the lower housing 104 may additionally include one or more additional functionally interactive elements such as for controlling a camera.

Generally, one of the upper housing 102 and the lower housing 104 will include a power supply, such as a battery, as well as computing capabilities, such as a display controller or a communication controller, which might be implemented at least in part through the use of one or more microprocessors.

As illustrated in FIG. 2, in addition to the first housing being able to move in a first direction 106 relative to the second housing, the first housing can also move in a second direction 120 relative to the second housing between an opened position and a closed position, along a second set of substantially parallel paths 122. In the illustrated embodiment, movement from a closed position to an opened position in each of the first direction 106 and the second direction 120 will expose a different portion of the keypad disposed on the surface of the lower housing 104. In the illustrated embodiment, the first direction 106 corresponds to a direction that is perpendicular to the side of the front facing of the device that is generally shorter, and the second direction 120 corresponds to a direction that is perpendicular to the side of the front facing that is generally longer. Movement between a closed position and an opened position in the first direction 106, generally exposes a numeric keypad, while movement between a closed position and an opened position in the second direction 120, generally exposes a fuller alphanumeric keypad. In the illustrated embodiment, the numeric keypad corresponds to a bell numeric keypad, and the fuller alphanumeric keypad corresponds to a qwerty keypad.

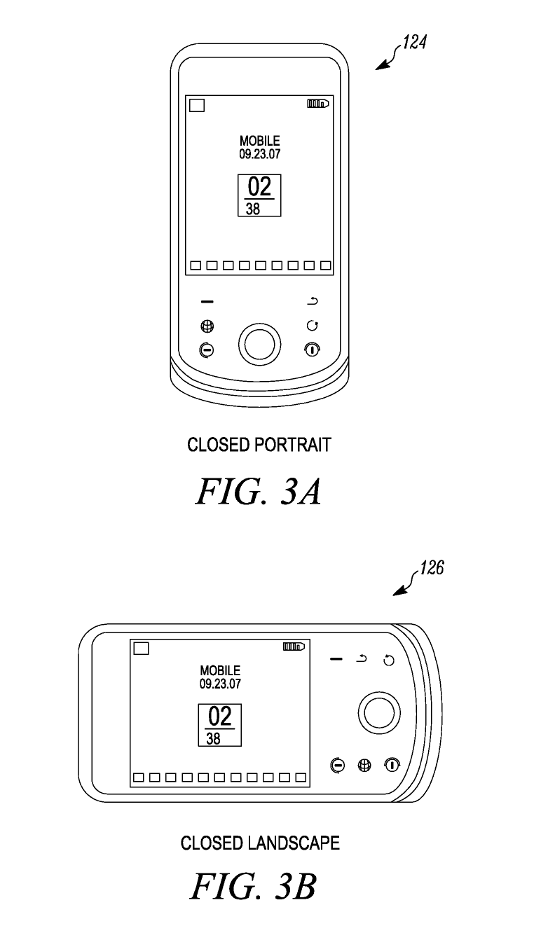

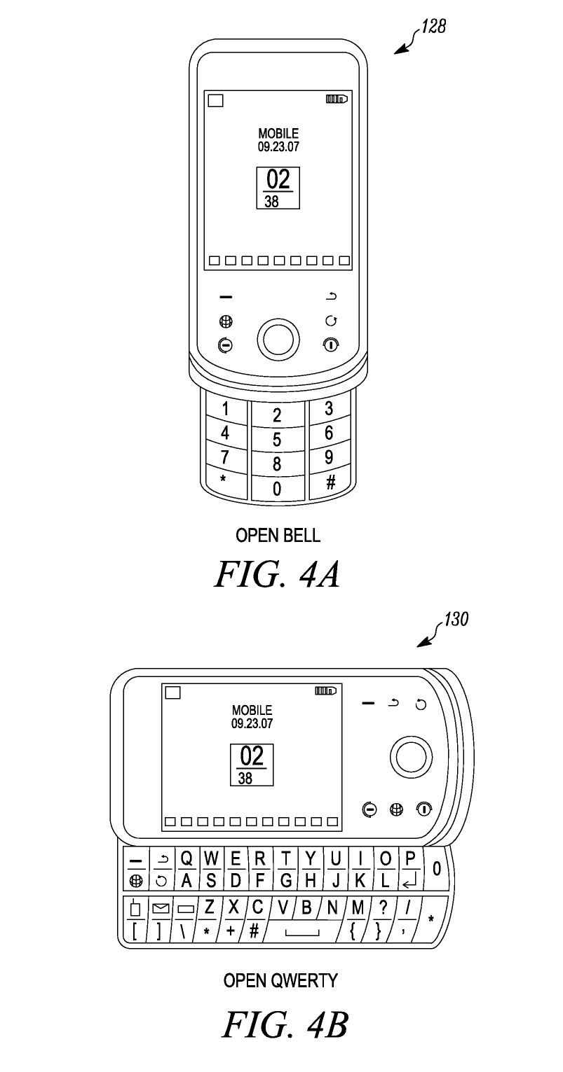

FIGS. 3A and 3B illustrate respective plan views of the exemplary hand-held device 100 in a closed portrait position 124 and a closed landscape position 126, while FIGS. 4A and 4B illustrate respective plan views of the exemplary hand-held device 100 in an opened portrait position 128 and an opened landscape position 130. Generally, the use of the terms portrait and landscape correspond to the orientation of the information being displayed on the screen 110, and correspondingly the use position of the device. The opened and closed portrait views 124 and 128 correspond to more typical display and device orientations associated with more traditional use operations for a cellular radio telephone supporting voice call communications. The opened and closed landscape views 126 and 130 correspond to more typical display and device orientations associated with more traditional use operations for a paging device supporting text messaging.

Generally, the different open configurations will each correspond to a different usage position relative to the user, where a user will generally interact with the device with the keypad positioned below the display regardless of the particular application being performed on the device, and in turn will result in a more predictable preferred orientation of information being displayed on the screen. In the closed position, both usage positions are typical and more often depend upon the particular application being performed on the device, as well as in some instances the user's preferences, which in turn will dictate the preferred orientation for the information being displayed on the screen. Consequently, it is not always as easy to predict a preferred orientation of information being displayed on the screen, when the hand-held device is in a closed position.

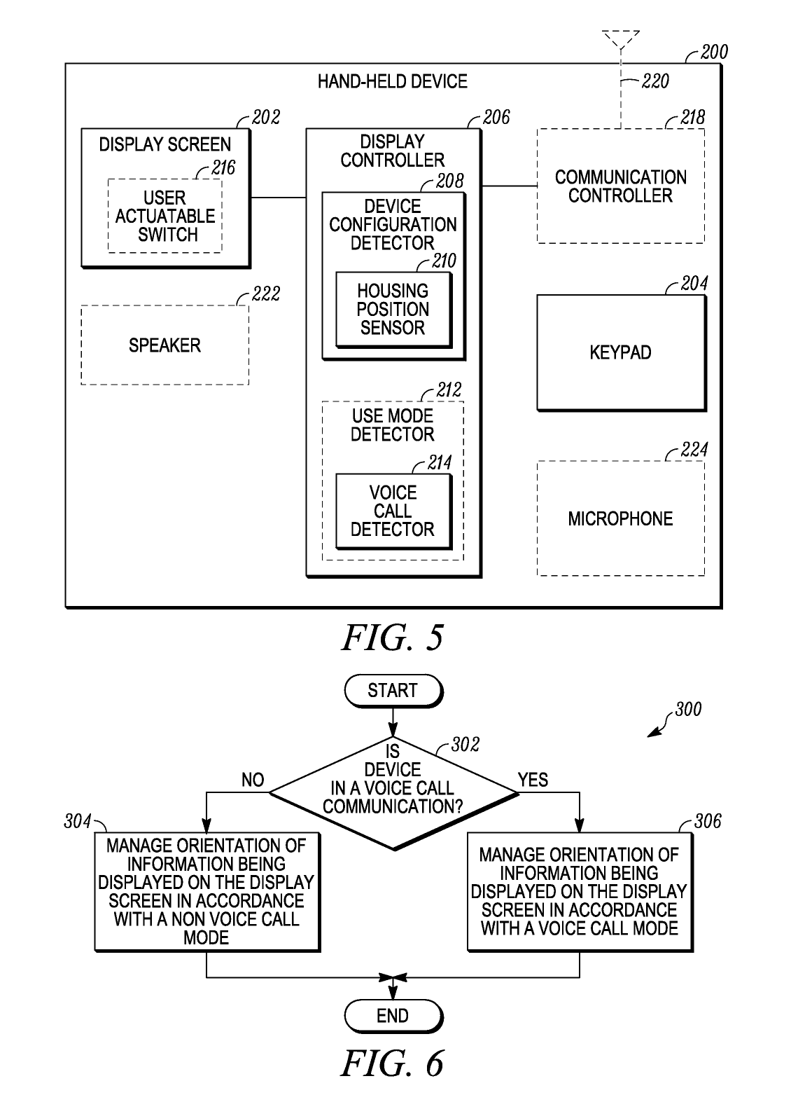

FIG. 5 illustrates a block diagram of a hand-held device 200 for managing the conveyance of information on a device display screen, in accordance with at least one embodiment of the present invention. The hand-held device 200 includes a display screen 202, typically associated with a first housing, and a keypad 204, typically associated with a second housing. The hand-held device 200 additionally includes a display controller 206, which includes a device configuration detector 208, which in at least some instances is adapted to detect the state (i.e. position) of the first housing relative to the second housing. In at least some embodiments, this might be implemented using one or more housing position sensors 210, that enable the relative position of the two housings to be tracked between a closed position and the multiple possible opened positions.

In at least some embodiments, the display controller may alternatively and/or additionally include or be coupled to a use mode detector 212, such as a voice call detector 214, which is adapted to identify the current use mode of the device 200, such as whether the device is currently engaged in a voice telephone conversation. In turn, the device configuration and/or the current use mode can be used by the device to manage the orientation of the information being displayed on the screen 202 of the hand-held device 200. In instances where the orientation is potentially unclear or less than certain, given the known device configuration and/or use mode, a user actuation switch 216 can be used to toggle between the available modes. In at least some instances, the user actuation switch 216 can be an icon associated with an actuation zone of a touch sensitive display. In at least some other instances, the user actuation switch 216 can be a button, accessible on the one of the housings, that includes a mechanical actuator. One skilled in the art will readily appreciate, that still further forms of user actuatable switches are possible without departing from the teachings of the present invention.

In conjunction with supporting voice communications, the hand-held device may further include a communication controller 218 incorporating one or more transmitters, receivers or transceivers for facilitating a communication connection with the communication network infrastructure. Furthermore, the communication controller 218 may be coupled to an antenna 220 for facilitating one or more forms of wireless communication. Still further, the hand-held device 200 can include a speaker 222 and a microphone 224 for converting between call data and communication signaling transmitted to and received from the network infrastructure, and an audio signal that can be produced and/or understood by a user.

Generally, the display controller is adapted for displaying information on the screen having a portrait orientation, when the first housing is slid relative to the second housing from a closed position to an opened position in a first direction, so as to properly orient the information being displayed on the screen relative to the user, with the exposed keypad positioned below the display. The display controller is further adapted for displaying information on the screen having a landscape orientation, when the first housing is slid relative to the second housing from a closed position to an opened position in a second direction, so as to properly orient the information being displayed on the screen relative to the user, with the alternatively exposed keypad positioned below the display. When the first housing relative to the second housing is moved from an opened position to a closed position, if the user is not engaged in a voice call, no change will automatically be made to the orientation of the information being displayed on the screen. If the user is engaged in a voice call, when the first housing is moved relative to the second housing from an opened position to a closed position, the information being displayed on the screen will be presented in portrait mode.

In addition to controlling the orientation of the information being displayed on the screen during a voice call communication, the call may simultaneously switch between a speaker mode and a private call mode, consistent with the orientation of the information which is being displayed switching between a landscape orientation and a portrait orientation, the assumption being that while in a voice call you will only switch to a landscape display orientation, when the device is changed to an opened position where the qwerty keypad is exposed. In such an instance, the user is likely wanting to reference information on the screen of the device, such as from a stored e-mail or data connection, while talking to the individual at the other end of the line. Correspondingly, when the device is changed to a closed position, while in a voice call, it is assumed that the user has finished referencing the information on the screen and is transitioning back to a private call mode, where the device microphone is placed proximate the user's mouth and the speaker is placed proximate the user's ear.

In at least some embodiments, the display controller 206 and the communication controller 218 can be implemented at least in part using one or more microprocessors, which might operate in conjunction with the one or more sets of prestored instructions to perform some of the functionality associated with the controllers. The one or more sets of prestored instructions can be stored in the corresponding microprocessor, or can be stored in one or more types of memory devices coupled to the microprocessor. Examples of various types of memories include forms of volatile and/or non-volatile memory, such as conventional ROM, EPROM, RAM, or EEPROM, as well as other forms of storage including fixed or removable discs. In some instances some or all of any memory for storing prestored instructions can be maintained separate from the device 200, for example on a server which might be communicatively coupled to the device 200.

While at least some of the functionality associated with one or more of the controllers can be managed under the direction of one or more sets of prestored instructions, one skilled in the art will readily recognize that the controllers can include additional and/or alternative forms, such as sequential station machines and operational logic circuitry, which could be implemented in hardware, software and/or both. To the extent that any portion of the functionality is implemented using hardware elements, the same could be constructed using discrete logic elements, gate array or programmable logic array type structures, and/or could be implemented in a VLSI type structure, without departing from the teachings of the present invention.

While the hand-held device has been described, in at least some instances as potentially corresponding to a wireless communication device, one skilled in the art will recognize that the hand-held device can take the form of other types of hand-held devices, for which managing the orientation of information for presentation on a screen may be beneficial, without departing from the teachings of the present invention. Further examples in addition to wireless communication devices, such as cellular radio telephones, and paging devices, without intending to be an exhaustive list include cordless telephones, personal digital assistants, portable computers, pen-based or keyboard-based handheld devices, remote control units, audio players (such as an MP3 player), digital cameras, and video game players.

FIG. 6 illustrates a flow diagram of a method 300 for managing the conveyance of information on a device display, in accordance with at least one embodiment of the present invention. The method 300 includes a determination 302 as to whether the device is in a voice call communication. If the device is not in a voice call communication, then the orientation of information being displayed on the display screen is managed 304 in accordance with not being in a voice call mode. If the device is in a voice call communication, then the orientation of information being displayed on the display screen is managed 306 in accordance with being in a voice call mode.

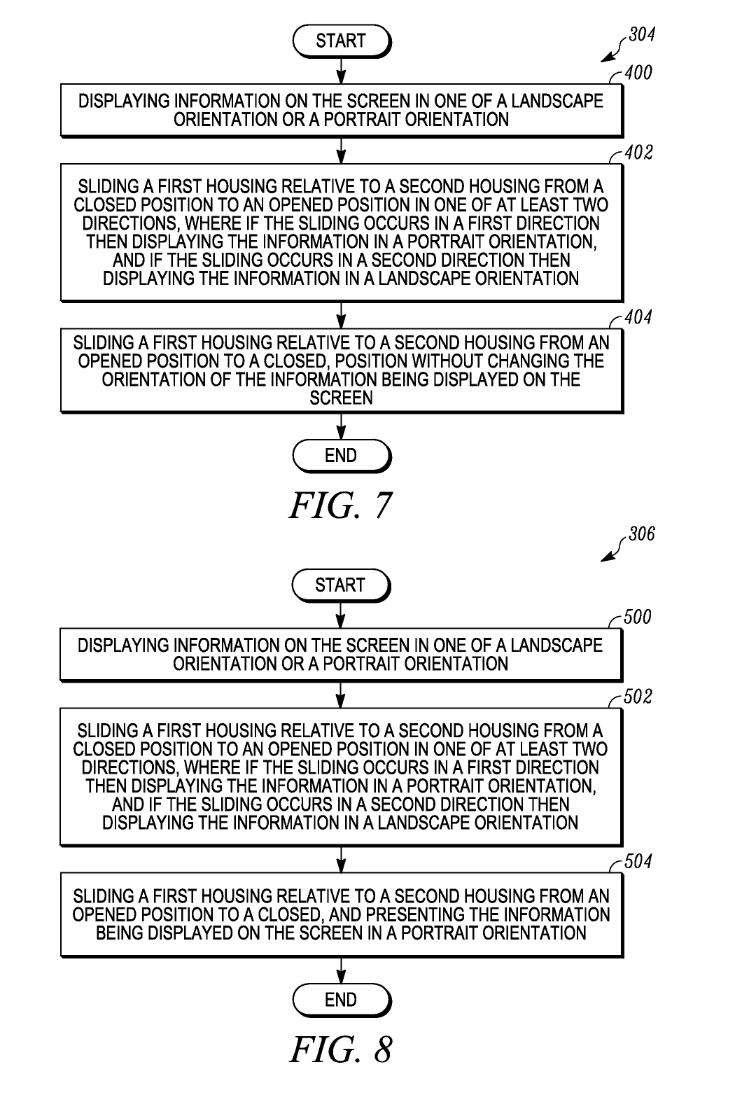

FIG. 7 illustrates a more detailed flow diagram of a method 304 for managing the conveyance of information on a device display, in accordance with at least one aspect of the present invention, when the device is not in a voice call mode. The method 304 includes displaying 400 information on the screen in one of a landscape orientation or a portrait orientation. A first housing is then slid 402 relative to a second housing from a closed position to an opened position in one of at least two directions, where if the sliding occurs in a first direction then displaying the information being displayed on the screen in a portrait orientation, and if the sliding occurs in a second direction then displaying the information being displayed on the screen in a landscape orientation. A first housing is then slid 404 relative to a second housing from an opened position to a closed position, without changing the orientation of the information being displayed on the screen.

FIG. 8 illustrates a more detailed flow diagram of a method for managing the conveyance of information on a device display, in accordance with at least one aspect of the present invention, when the device is in a voice call mode. The method 306 includes displaying 500 information on the screen in one of a landscape orientation or a portrait orientation. A first housing is then slid 502 relative to a second housing from a closed position to an opened position in one of at least two directions, where if the sliding occurs in a first direction then displaying the information being displayed on the screen in a portrait orientation, and if the sliding occurs in a second direction then displaying the information being displayed on the screen in a landscape orientation. A first housing is then slid 504 relative to a second housing from an opened position to a closed position, and presenting the information being displayed on the screen in a portrait orientation.

In this way, a device can take into account the devices physical configuration and current use mode in managing the orientation of information being displayed on the screen, while similarly allowing the user to toggle between multiple display orientations in instances where a preferred orientation based upon the physical configuration and the current use mode may be ambiguous.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method for managing the orientation of information being displayed on the screen of a hand-held device having a two part slidable housing including a first housing and a second housing where the two housings are adapted to slide separately in multiple directions relative to one another along a corresponding path substantially parallel to a front facing of the device between an opened position and a closed position, the method comprising:
displaying information on the screen in one of a landscape orientation or a portrait orientation;
sliding the first housing of the hand-held device relative to the second housing of the hand-held device from a closed position, where the first housing and the second housing substantially overlap, to an opened position where at least a portion of the first housing or a portion of the second housing move from an overlapping position to a non-overlapping position, relative to the other one of the first housing and the second housing,
wherein if the first housing slides relative to the second housing in a first direction the information will be displayed on the screen in a portrait orientation, and,
wherein if the first housing slides relative to the second housing in a second direction, which is substantially perpendicular to the first direction, the information will be displayed on the screen in a landscape orientation;
sliding the first housing of the hand-held device relative to the second housing of the hand-held device from an opened position to a closed position without changing the orientation of the information being displayed on the screen.

2. A method for managing the orientation of information being displayed on the screen of a hand-held device in accordance with claim 1,
wherein relative to the front facing of the hand-held device, the hand-held device has a width different than the length, where the width is shorter than the length; and
wherein the first direction of sliding is substantially perpendicular to the side of the front facing of the hand-held device that is shorter, and the second direction of sliding is substantially perpendicular to the side of the front facing of the hand-held device that is longer.

3. A method for managing the orientation of information being displayed on the screen of a hand-held device in accordance with claim 2, wherein sliding the first housing of the hand-held device relative to the second housing of the hand-held device from a closed position, where the first housing and the second housing substantially overlap, to an opened position where at least a portion of the first housing or a portion of the second housing move from an overlapping position to a non-overlapping position, relative to the other one of the first housing and the second housing in a first direction, exposes a numeric keypad.

4. A method for managing the orientation of information being displayed on the screen of a hand-held device in accordance with claim 3, wherein the numeric keypad is a bell numeric keypad.

5. A method for managing the orientation of information being displayed on the screen of a hand-held device in accordance with claim 2, wherein sliding the first housing of the hand-held device relative to the second housing of the hand-held device from a closed position, where the first housing and the second housing substantially overlap, to an opened position where at least a portion of the first housing or a portion of the second housing move from an overlapping position to a non-overlapping position, relative to the other one of the first housing and the second housing in a second direction, exposes a full alphanumeric keypad.

6. A method for managing the orientation of information being displayed on the screen of a hand-held device in accordance with claim 5, wherein the full alphanumeric keypad is a qwerty keypad.

7. A method for managing the orientation of information being displayed on the screen of a hand-held device in accordance with claim 1,
wherein the hand-held device is a radiotelephone adapted for supporting a voice call communication connection;
wherein when sliding the first housing of the hand-held device relative to the second housing of the hand-held device from an opened position to a closed position, the orientation of the information being displayed on the screen does not change when the hand-held device is not in a voice call communication connection;
wherein when the hand-held device is in a voice call communication connection, and the first housing of the hand-held device slides relative to the second housing of the hand-held device from an opened position to a closed position, the orientation of the information being displayed on the screen is presented in a portrait orientation.

8. A method for managing the orientation of information being displayed on the screen of a hand-held device in accordance with claim 7,
wherein relative to the front facing of the hand-held device, the hand-held device has a width different than the length, where the width is shorter than the length;
wherein the first direction is substantially perpendicular to the side of the front facing of the hand-held device that is shorter, and the second direction is substantially perpendicular to the side of the front facing of the hand-held device that is longer, and
wherein when the hand-held device is in a voice call communication connection, and the first housing of the hand-held device is slid relative to the second housing of the hand-held device from a closed position, where the first housing and the second housing substantially overlap, to an opened position where at least a portion of the first housing or a portion of the second housing move from an overlapping position to a non-overlapping position, relative to the other one of the first housing and the second housing in a second direction, a voice input and output of the voice call communication connection will default to a speaker phone mode.

9. A method for managing the orientation of information being displayed on the screen of a hand-held device in accordance with claim 8, wherein the use of a headset will override a default to a speaker phone mode for a voice input and output of the voice call communication connection, when the first housing of the hand-held device is slid relative to the second housing of the hand-held device from a closed position to an opened position in a second direction.

10. A method for managing the orientation of information being displayed on the screen of a hand-held device in accordance with claim 7, wherein when the hand-held device is in a voice call communication connection, and the first housing of the hand-held device is slid relative to the second housing of the hand-held device from an opened position to a closed position, a voice input and output of the voice call communication connection will default to a regular phone mode, wherein the hand-held device is adapted to receive a user's ear proximate a speaker and a user's mouth proximate a microphone.

11. A method for managing the orientation of information being displayed on the screen of a hand-held device in accordance with claim 1, further comprising:
when the first housing of the hand-held device is in a closed position relative to the second housing of the hand-held device, providing a user actuatable switch for toggling the orientation of the information being displayed on the screen between a landscape orientation and a portrait orientation;
detecting the actuation of the user actuatable switch; and
if the user actuatable switch is detected as having been actuated, then switching the orientation of the information being displayed on the screen between a landscape orientation and a portrait orientation.

12. A method for managing the orientation of information being displayed on the screen of a hand-held device in accordance with claim 11, wherein the user actuatable switch is a touch sensitive icon displayed on the screen.

13. A method for managing the orientation of information being displayed on the screen of a hand-held device in accordance with claim 11, wherein the user actuatable switch is a button including a mechanical actuator.

14. A method for managing the orientation of information being displayed on the screen of a hand-held device in accordance with claim 13, wherein the button has a state that can be changed between active and inactive.

15. A hand-held device having a two part slidable housing comprising:
a first housing including a display;
a second housing including a keypad, where the first housing and the second housing are adapted to slide separately in multiple directions relative to one another along a corresponding path substantially parallel to a front facing of the device between an opened position and a closed position; and
a display controller, which is adapted for displaying information on the screen in one of a landscape orientation or a portrait orientation,
wherein if the first housing is slid relative to the second housing from a closed position to an opened position in a first direction the information will be displayed on the screen in a portrait orientation, and if the first housing slides relative to the second housing from a closed position to an opened position in a second direction, which is substantially perpendicular to the first direction, the information will be displayed on the screen in a landscape orientation, and
wherein if the first housing of the hand-held device is slid relative to the second housing of the hand-held device from an opened position to a closed position without changing the orientation of the information being displayed on the screen.

16. A hand-held device having a two part slidable housing in accordance with claim 15, wherein the hand-held device is a radio telephone further comprising a wireless transceiver, and wherein the display controller does not change the orientation of the information being displayed on the screen, when the first housing of the hand-held device is slid relative to the second housing of the hand-held device from an opened position to a closed position, when the hand-held device is not in a voice call communication connection.

17. A hand-held device having a two part slidable housing in accordance with claim 16, wherein when the hand-held device is in a voice call communication connection and the first housing of the hand-held device slides relative to the second housing of the hand-held device from an opened position to a closed position, the display controller is adapted to present the information being displayed on the screen in a portrait orientation.
